(19) United States
(12) Patent Application Publication
(10) Pub. No.: US 2026/0117859 A1
(43) Pub. Date: Apr. 30, 2026

(54) VEHICLE WITH A DUAL-CLUTCH TRANSMISSION

(71) Applicant: AUDI AG, Ingolstadt (DE)

(72) Inventors: Lutz GUNDLACH, Ingolstadt (DE); Pina Michaela WRITZEL, Kösching (DE)

(73) Assignee: AUDI AG, Ingolstadt (DE)

(21) Appl. No.: 19/363,536

(22) Filed: Oct. 20, 2025

(30) Foreign Application Priority Data
Oct. 25, 2024 (DE) 10 2024 131 257.2

(51) Int. Cl. F16H 61/04

(52) U.S. Cl. CPC F16H 61/0403; F16H 2061/0407

(57) ABSTRACT

Embodiments herein relate to a vehicle with a dual-clutch transmission in which, in preparation for a target gear shift in a separating clutch opening process, the still closed separating clutch of the first subtransmission is fully opened so that a torque-free disengagement of the current gear is ensured, and in a gear disengagement process, a current gear in the first subtransmission is disengaged torque-free. According to the invention, the gear disengagement process is started before the expiration of the separating clutch opening process, whereby the separating clutch opening process and the gear disengagement process temporally overlap in an overlap time interval.

### TECHNICAL FIELD

Embodiments herein relate to a vehicle with a dual-clutch transmission as well as to a method for operating such a dual-clutch transmission.

### BACKGROUND

In a generic dual-clutch transmission, its first subtransmission and its second subtransmission can be activated in driving mode by actuating the respective associated first and second separating clutches. Each of the subtransmissions has at least one synchronizing clutch with which a gear can be engaged.

With an electronic shift control unit of the dual-clutch transmission, an indirect gear shift without interruption in traction can be carried out, in which, in driving mode, there is first a shift from a current gear of the first subtransmission to an intermediate gear of the second subtransmission and then further to the target gear of the first subtransmission.

In preparation for such a target gear shift, an evaluation module controls a clutch control unit in order to completely open the still closed clutch of the first subtransmission in a separating clutch opening process so that a torque-free disengagement of the current gear is ensured. In addition, the evaluation module controls the shift control unit in order to disengage the current gear in the first subtransmission without torque in a gear disengagement process.

In the prior art, the gear disengagement process is only carried out after the conclusion of the separating clutch opening process, i.e., only when the separating clutch is fully open. Therefore, in the prior art, the time period for preparing the target gear shift, i.e., the time period until the target gear is finally engaged, is correspondingly long.

From DE 10 2005 049 178 A1, a control method for an automated manual transmission is known which enables a gear change, i.e., a downshift with minimal interruption of traction, in that the phase of reducing the drive torque of the drive motor, the phase of separating the power connection in the automated manual transmission and the phase of adjusting the rotational speed of the transmission input shaft to a suitable target rotational speed are configured in such a way that they at least partially overlap in time.

From DE 10 2006 058 973 A1, a method for controlling the operation of a parallel transmission with two subtransmissions is known, the input shafts of which can each be connected to a drive shaft by means of a clutch and which act on a common output shaft on the output side. During a target shift from a current gear that is engaged in a subtransmission whose clutch is closed, to a target gear that is engaged in the other subtransmission whose clutch is open, the closed clutch is increasingly opened, and at the same time the open clutch is increasingly closed. During the increasing closing of the clutch assigned to the subtransmission containing the target gear, an attempt is made to disengage the current gear.

### BRIEF DESCRIPTION OF THE DRAWINGS/FIGURES

FIG. 1 shows the transmission structure of a drive train of a vehicle with a dual-clutch transmission installed therein.

FIG. 2 shows a diagram with which a timing sequence for a gear disengagement according to a comparative example not covered by embodiments herein.

FIG. 3 shows a diagram corresponding to FIG. 2, in which the timing of a gear disengagement according to some embodiments.

### DETAILED DESCRIPTION

The object of some embodiments herein may be to provide a vehicle with a dual-clutch transmission in which the total shift time for a gear change in the same subtransmission is reduced in comparison to the prior art.

The object may be achieved by the features of the independent claims.

Embodiments herein relate to a vehicle with a dual-clutch transmission in which, in driving mode, its first subtransmission and its second subtransmission can be activated by actuating the respective associated first and second separating clutches. Each of the subtransmissions has at least one synchronizing clutch with which a gear can be engaged. By means of an electronic shift control unit of the dual-clutch transmission, an indirect gear shift without interruption in traction can be carried out, in which, in driving mode, there is first a shift from a current gear of the first subtransmission to an intermediate gear of the second subtransmission and is then shifted further to the target gear of the first subtransmission. In preparation for such a target gear shift, an evaluation module controls a clutch control unit in order to completely open the still closed clutch of the first subtransmission in a separating clutch opening process so that a torque-free disengagement of the current gear is ensured. In addition, the evaluation module controls the shift control unit in order to disengage the current gear in the first subtransmission without torque in a gear disengagement process.

According to some embodiments, the following measure is taken to reduce the total shift time in a gear change in the same subtransmission: The gear disengagement process no longer starts until the separating clutch is fully opened, i.e., after conclusion of the separating clutch opening process. Rather, the evaluation module controls the shift control unit in such a way that the gear disengagement process starts before the completion of the separating clutch opening process. According to some embodiments, the separating clutch opening process and the gear disengagement process therefore overlap in an overlap time interval, which overall leads to a reduced total switching time in comparison to the prior art.

Some embodiments are based on the finding that the separating clutch opening process can be divided into an initial torque-conducting opening phase until reaching a kiss point, and a subsequent torque-free opening phase after reaching the kiss point in which a torque-free clutch clearance builds up in the separating clutch. According to some embodiments, the evaluation module controls the shift control unit in such a way that the gear disengagement process starts at least during the torque-free opening phase of the separating clutch opening process.

Some embodiments are alternatively and/or additionally based on the finding that the gear disengagement process can also be divided, namely into an initial torque-conducting disengagement start phase in which the gearshift element uses up mechanical gearshift play, namely without an adjustment movement of the gearshift element from its shifting position to its neutral position, and into a subsequent shifting phase in which the gearshift element adjusts from its shifting position towards the neutral position.

Against this background, the evaluation module can apply the following shift strategy: The evaluation module can thus control the shift control unit in such a way that the torque-conducting disengagement start phase already begins before the kiss point of the separating clutch of the first subtransmission. In this case, the kiss point of the separating clutch of the first subtransmission is reached, during which the torque-conducting disengagement start phase of the gearshift element is already underway. After reaching the kiss point (i.e., after reaching an absence of torque in the separating clutch), the shifting phase of the gear disengagement process begins in which the gear shift element releases torque-free from its shifting position towards the neutral position.

In a technical implementation, the evaluation module can be signal-linked to a sensor system that detects a contact pressure acting in the respective separating clutch or a parameter correlating therewith. The evaluation module can determine the kiss point of the separating clutch based on the detected contact pressure as well as a transferable clutch torque corresponding therewith.

With regard to a target gear shift without interruption of traction, this can be designed as an indirect shift in which the current gear of the first subtransmission is first shifted to an intermediate gear of the second subtransmission. Then there may be further shifting from the intermediate gear of the second subtransmission to the target gear of the first subtransmission.

After the current gear has been disengaged, i.e., after the conclusion of the preparation time period, the target gear shift is carried out, during which the evaluation module controls the shift control unit so that the target gear is engaged in the first subtransmission. The clutch control unit is then activated to close the separating clutch of the first subtransmission, whereby the shifting of the target gear is completed.

In a specific embodiment, a vehicle drive unit, in particular an internal combustion engine, with a power output shaft is alternately in driving connection with either a first drive shaft or a second drive shaft via the two powershiftable separating clutches of the dual-clutch transmission. The first subtransmission or the second subtransmission can be activated by means of the two drive shafts.

Fixed and loose gears are arranged on the two drive shafts as well as on an output shaft, in particular axially parallel thereto and, while forming gear stages, are combined into gear sets in which the loose gears can be coupled to the respective transmission shaft by means of the gear shift elements.

The gearshift elements installed in the dual-clutch transmission can be implemented as synchronous clutches that are axially adjustable on one or both sides. Such a synchronous clutch has a sliding sleeve which can be axially adjusted over a shift path by means of a shift fork. The shift fork can be adjusted over its adjustment travel using, for example, a hydraulically operated actuator. A sliding sleeve internal toothing is mounted in an axially adjustable manner on a corresponding external toothing of a sliding sleeve carrier arranged for conjoint rotation on a gear shaft. The sliding sleeve can be moved with the help of the shift fork into a shifting position in which the sliding sleeve internal teeth mesh with both the external teeth of the sliding sleeve carrier and the external teeth of a loose gear clutch body.

An embodiment is described below with reference to the attached figures.

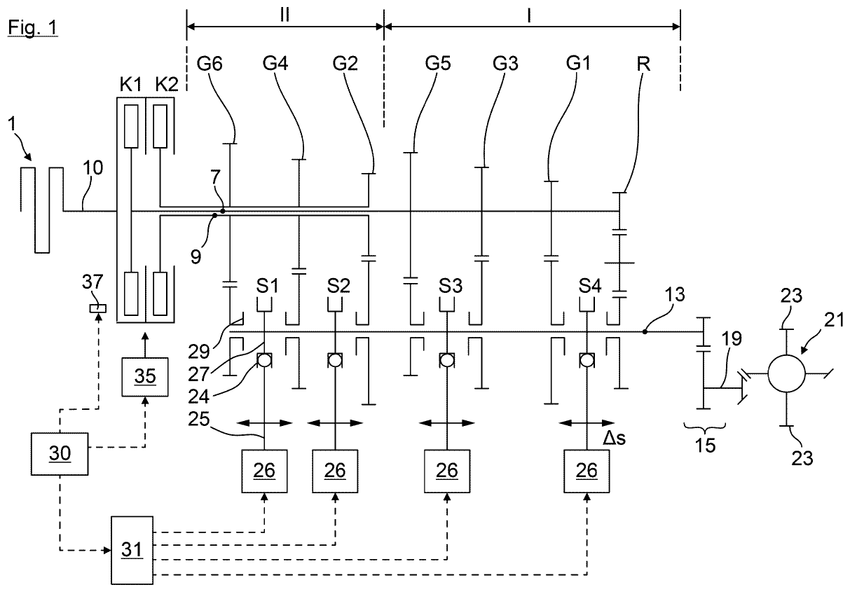

FIG. 1 shows a transmission structure of a drive train of a motor vehicle, which is substantially composed of an internal combustion engine 1 and a dual-clutch transmission. The dual clutch transmission has a first drive shaft 7 and a second drive shaft 9.

These are arranged coaxially and can be connected in a torque-conducting manner to a power output shaft 10 of the internal combustion engine 1 via two, for example hydraulically actuatable power-shiftable separating clutches K1, K2. The first drive shaft 7 is realized in FIG. 1 as a solid shaft which is guided coaxially within the second drive shaft 9 realized as a hollow shaft. An output shaft 13 is provided axially parallel to the two drive shafts 7, 9. Via a gear stage 15 with spur gears, this drives an input shaft 19 of an axle differential 21. Flange shafts 23 lead from the axle differential 21 on both sides to vehicle wheels (not shown).

By means of the first and second drive shafts 7, 9, a first subtransmission I and a second subtransmission II of the dual clutch transmission can be activated. In the figure, the first subtransmission I is axially spaced from the double clutch K1, K2 with the interposition of the second subtransmission II. Fixed and loose gears are arranged in gear planes on the two drive shafts 7, 9 as well as on the output shaft 13. These are combined into gear sets to form six forward gear stages G1 to G6 and one reverse gear stage R. In the figure, the loose gears of all gear stages are positioned on the output side of the output shaft 13. The loose gears can be shifted with the aid of gear shift elements S1 to S4 which are also positioned on the output shaft 13.

Each of the gear shift elements S1 to S4 is realized as a synchronous clutch with a sliding sleeve 24 which is axially adjustable on both sides by means of an indicated shift fork 25 over an adjustment travel As. The sliding sleeve 24 sits with its internal toothing (not shown) on a corresponding external toothing of a sliding sleeve carrier 27 arranged for conjoint rotation on the output shaft 13. Each of the sliding sleeves 24 is positioned in a neutral position in FIG. 1. Starting from the neutral position, the sliding sleeves 24 can be moved into a shifting position in order to engage one of the gears G1 to G6 or R. In the shifting position, the sliding sleeve internal toothing mesh with the sliding sleeve carrier 27 on the one hand and with the external toothing of a coupling body 29 of a loose gear on the other hand.

In FIG. 1, each of the shift forks 25 is operatively connected to an actuator 26, for example hydraulically operating, which can be controlled by a shift control unit 31.

When accordingly actuated, the shift fork 25 is axially adjusted over an adjustment travel Δs in order to bring the associated shift sleeve 24 into or out of coupling engagement with a loose gear.

In FIG. 1, the shift control unit 31 as well as a clutch control unit 35 can be controlled by an evaluation module 30. The evaluation module 30 is signal-linked to a sensor system 37, by means of which a contact pressure acting in the separating clutches K1, K2 or a parameter correlating therewith is detected. The evaluation module 30 determines the kiss point KP of the separating clutch K1, K2 on the basis of the detected contact pressure as well as a transmittable clutch torque corresponding therewith.

A shifting strategy is saved in the evaluation module 30 in order to carry out an indirect gear change without interruption of traction, in which a shift is made from a current gear of one subtransmission via an intermediate gear of the other subtransmission to a target gear of one subtransmission.

A core of embodiments herein consists of reducing the total shift time when changing gears from the current gear to the target gear. This is achieved by a gear disengagement of the current gear that takes place earlier than in the prior art. This also allows the target gear shift, i.e., the engagement of the target gear, to take place at an earlier point in time. The target gear can namely only be engaged when the current gear is disengaged in order to avoid gear set blocking in the subtransmission.

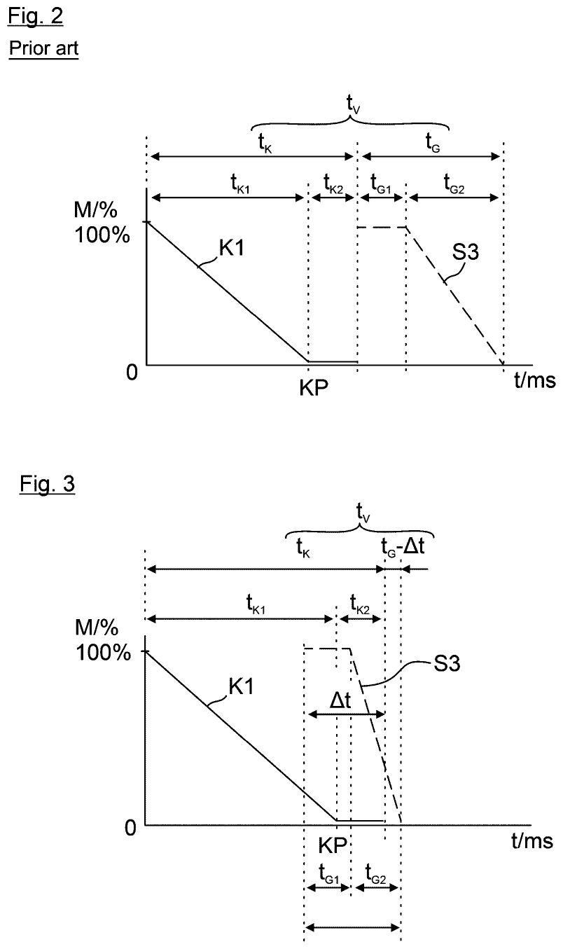

For a simpler understanding of the present disclosure a comparative example not covered by embodiments herein is first explained with reference to FIG. 2. In the comparative example in FIG. 2, an indirect gearshift is considered as an example, in which the current gear is the third gear G3 in the first subtransmission I, while the target gear is the first gear G1 in the first subtransmission I and an intermediate gear is the second gear G2 in the second subtransmission II. Accordingly, to prepare the target gear shift, the evaluation module 30 controls the clutch control unit 35 to completely open the still closed separating clutch K1 in a separating clutch opening process t_{K} (see solid line in the diagram) of the first subtransmission I. In this way, a torque-free disengagement of the current gear G3 is ensured. After completion of the separating coupling opening process t_{K}, the evaluation module 30 controls the shift control unit 31 in order to to move the gearshift element S3 in a gear disengagement process t_{G} (see dashed line in the diagram) from its shift position to its neutral position so that the current gear G3 in the first subtransmission I is disengaged torque-free. The time period t_{V} indicated in the diagram in FIG. 2 to prepare the target gear shift, therefore results from the clutch opening process t_{K} and from the gear disengagement process t_{G}. In the diagram in FIG. 2, the gear disengagement process to starts only when the separating clutch K1 is fully opened, i.e., when the separating clutch opening process t_{K} is completely finished. Therefore, in FIG. 2, the preparation for the target gear shift lasts a correspondingly long preparation time period t_{V}.

In contrast to FIG. 2, the diagram in FIG. 3 shows the time sequence for a gear disengagement according to some embodiments. The gear disengagement according to some embodiments are based on the following finding: The separating clutch opening process t_{K} can be divided into an initial torque-conducting opening phase t_{K1} which continues until a kiss point KP is reached, and into a subsequent torque-free opening phase t_{K2} which starts with the kiss point KP. In the torque-free opening phase t_{K2}, a torque-free clutch clearance builds up in the separating clutch K1.

The kiss point KP defines a position of a separating clutch actuator from which torque is transmitted via the separating clutch when the contact pressure increases, and from which torque-free clutch clearance is established when the contact pressure decreases.

In the same way, the gear disengagement process to can be divided into an initial torque-conducting disengagement start phase t_{G1} and into a subsequent shifting phase t_{G2}. In the disengagement start phase t_{G1}, the gear shift element S3 requires a mechanical gearshift play, namely without any adjustment movement of the gear shift element S3 taking place. In the subsequent shifting phase t_{G2}, the gear shift element S3 in contrast is adjusted by adjustment travel Δs (FIG. 1) from its shifting position towards its neutral position.

According to the diagram in FIG. 3, this knowledge is used as follows when changing gears: Accordingly, the evaluation module 30 controls the shift control unit 31 in such a way that the torque-conducting disengagement start phase toi is not started only after completion of the separating coupling opening process tk begins, but rather before the kiss point KP of the separating clutch K1 of the first subtransmission I. As soon as the separating clutch K1 of the first subtransmission I reaches the kiss point KP, the torque-conducting disengagement start phase t_{G1} of the gearshift element S3 is already running. After reaching the kiss point KP (and before the expiration of the separating clutch process t_{K}), the shifting phase t_{G2} of the gear disengagement process t_{G} starts in order to adjust the gear shift element S3 from its shifting position towards the neutral position without any torque. Due to the earlier (in comparison to FIG. 2) gear disengagement process t_{G}, the separating clutch opening process t_{K} and the gear disengagement process t_{G} overlap during an overlap time interval Δt. The preparation time period t_{V} to prepare the target gear shift is therefore significantly reduced in comparison to the prior art (FIG. 2).

After the third gear G3 has been disengaged, i.e., after the preparation time period t_{V}, the target gear shift is carried out. In the target gear shift, the evaluation module 30 controls the shift control unit 31 so that the target gear G1 in the first subtransmission I is engaged without torque by adjusting the gear shift element S4. The clutch control unit 35 is then activated to again close the separating clutch K1 of the first subtransmission I.

### List of Reference Numbers

1 internal combustion engine
7 first drive shaft
9 second drive shaft
10 power output shaft
13 output shaft
15 spur gear stage
19 input shaft
21 axle differential
23 flange shafts
24 shift sleeve
25 shift fork
26 actuator
27 shift sleeve carrier
29 loose gear clutch body
30 evaluation module
31 switch control unit
35 clutch control unit
37 sensor system
G1 to G6 forward gears
R reverse gear
K1, K2 separating clutches
S1 to S4 gearshift elements
KP kiss point
Δs adjustment travel
t_{K} separating coupling opening process
t_{K1} torque-conducting opening phase
t_{K2} torque-free opening phase
t_{G} gear disengagement process
t_{G1} torque-conducting disengagement start phase
t_{G2} shifting phase
Δt overlap time interval
t_{V} preparation time period

1-9. (canceled)

10. A vehicle with a dual-clutch transmission, the vehicle comprising:
a first subtransmission and a second subtransmission, wherein each of the first subtransmission and the second subtransmission are activated by actuating a respective associated first separating clutch and a respective associated second separating clutch, and wherein each of the first subtransmission and the second subtransmission has at least one gearshift element, the at least one gearshift element being a synchronizing clutch with which a gear can be engaged;
an evaluation module configured to control a shift control unit and a clutch control unit;
the shift control unit configured to cause a gear shift from a current gear into a target gear of the first subtransmission;
in preparation for the gear shift, the evaluation module is configured to control the clutch control unit to open, from a closed position, the first separating clutch of the first subtransmission in a separating clutch opening process so that a torque-free disengagement of the current gear is ensured;
the evaluation module is further configured to control the shift control unit in order to disengage the current gear in the first subtransmission without torque in the gear disengagement process, the evaluation module being further configured to control the shift control unit so that the gear disengagement process starts before an expiration of the separating clutch opening process, thereby causing the separating clutch opening process and the gear disengagement process to temporally overlap in an overlap time interval,
wherein the gear shift takes a time period, the time period including a first time period for the opening and a second time period for the disengaging, and wherein the first time period overlaps with the second time period.

11. The vehicle according to claim 10, wherein the separating clutch opening process is divided into an initial torque-conducting opening phase until reaching a kiss point, and into a subsequent torque-free opening phase after reaching the kiss point in which a torque-free clutch clearance builds up in the first separating clutch, such that the evaluation module controls the shift control unit in such a way that the gear disengagement process starts at least during the torque-free opening phase of the separating clutch opening process.

12. The vehicle according to claim 10, wherein the gear disengagement process is divided into an initial torque-conducting disengagement start phase in which the at least one gearshift element uses up mechanical gearshift play, without an adjustment movement of the at least one gearshift element, and into a subsequent shifting phase in which the at least one gearshift element moves from its shifting position towards a neutral position.

13. The vehicle according to claim 10, wherein a torque-conducting disengagement start phase starts before reaching a kiss point of the separating clutch of the first subtransmission, and the separating clutch reaches the kiss point during the torque-conducting disengagement start phase.

14. The vehicle according to claim 10, wherein the vehicle is further configured to:
detect, via the evaluation module, a contact pressure acting in the first separating clutch, wherein the evaluation module is signal-linked to a sensor system; and
determine the kiss point of the first separating clutch based on the contact pressure and a transmittable clutch torque.

15. The vehicle according to claim 10, wherein to shift the current gear to the target gear the vehicle is further configured to:
in response to disengaging the current gear, activate the shift control unit so that the target gear is engaged in the first subtransmission; and
close, via a clutch control unit, the first separating clutch based on shifting the current gear to the target gear.

16. The vehicle according to claim 10, wherein to shift the current gear to the target gear the vehicle is further configured to:
shift the current gear of the first subtransmission to an intermediate gear of the second transmission.

17. The vehicle according to claim 10, wherein the vehicle is further configured to:
activate, via a combustion engine, a first drive shaft using the separating clutch; and
arrange fixed and loose gears axially parallel to the first drive shaft and a second drive shaft respectively, wherein the loose gears are coupled to a respective drive shaft.

18. A method for operating a dual-clutch transmission of a motor vehicle comprising:
controlling, by an evaluation module, a shift control unit and a clutch control unit;
shifting, by the shift control unit, a current gear into a target gear of a first subtransmission;
opening, by the clutch control unit, the first separating clutch coupled to the first subtransmission to ensure a torque free disengagement of the current gear, wherein the first subtransmission comprises a synchronizing clutch that engages a gear; and
disengaging, by the shift control unit, the current gear of the first subtransmission based on the opening the first separating clutch, the evaluation module controlling the shift control unit so that the disengaging starts before an expiration of the opening, wherein the shifting takes a time period, the time period including a first time period for the opening and a second time period for the disengaging, wherein the first time period overlaps with the second time period.
